(19) United States
(12) Patent Application Publication
(10) Pub. No.: US 2006/0255744 A1
(43) Pub. Date: Nov. 16, 2006

(54) LED illuminating module

(75) Inventors: Wen-Lung Wu, Hsinchu County (TW); Chung-Ping Ku, Hsinchu County (TW); Li-Ling Lee, Hsinchu County (TW); H. J. Lee, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/188,841

(22) Filed: Jul. 26, 2005

(30) Foreign Application Priority Data
May 13, 2005 (TW) 94115525

(51) Int. Cl. H05B 37/00; H05B 41/14

(52) U.S. Cl. 315/86

(57) ABSTRACT

A LED illuminating module is provided. A plurality of LEDs are directly disposed on a circuit board to thin out the whole module and minimize its volume. A problem that the circuit board of the conventional LED illuminating module and a board provided with the LEDs are separate is resolved.

### BACKGROUND OF THE INVENTION

1. Field of the Invention

The present invention relates to a LED illuminating module, more particularly a LED illuminating module that is thinned out and reduced in volume by conjoining the LEDs and the circuit board.

2. Description of the Related Art

A wide variety of lighting devices and decorative art ornaments that use LED illuminating modules are now available on the market. However, no matter which products the LED illuminating module is applied to or what kind of circuit design it uses to produce monochromatic or polychromatic illumination or dimming effect, the optical and electrical components of the LED illuminating module are separate, that is the circuit board and the LED board are separate, and traditional LED modules use bigger and heavier transformer. Such design of LED illuminating module lacks efficiency and is not suitable for light-weight, thin, short and small products. The assembly for the module is also more time-consuming and incurs higher cost.

### SUMMARY OF THE INVENTION

The object of the present invention is to provide a light and thin LED illuminating module that integrates circuit board and LED board to reduce assembly time and costs, and the volume of module.

To achieve the aforesaid object, the LED illuminating module according to the present invention comprises a circuit board and a plurality of LEDs disposed on the circuit board. Preferably, the circuit board is double-sided.

Preferably, a plurality of electronic components, comprising transformer, controller, capacitor, resistors and electrical terminal, are provided on the circuit board. The controller is a light color controller.

Preferably, the electrical terminal is externally connected with a power converter.

Preferably, the electrical terminal is externally connected with a battery.

The object and features of the invention are described in detail with accompany drawings. It should understood that the drawings and example presented below are only for description purpose and not meant to limit or confine this invention.

### BRIEF DESCRIPTION OF THE DRAWINGS

FIG. 1 is a side view of the LED illuminating module according to the invention.

FIG. 2 is a diagram showing the LED illuminating module according to the invention externally connected with an AC/DC converter.

FIG. 3 is a diagram showing the LED illuminating module according to the invention externally connected with a battery.

FIG. 4 is an embodiment of a screw-type light bulb for illumination to which the invention being applied.

FIG. 5 is an embodiment of an acrylic rod for illumination or ornament to which the invention being applied.

### DETAILED DESCRIPTION OF THE INVENTION

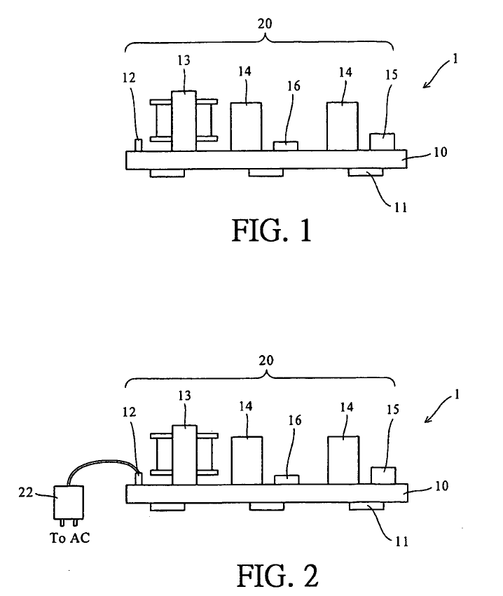

As shown in FIG. 1, the LED illuminating module 1 of the invention comprises a circuit board 10 and a plurality of LEDs 11. The circuit board 10 contains a plurality of electronic components 20, including an electrical terminal 12, a transformer 13, a plurality of capacitors 14, a controller 15, and a plurality of resistors 16. The circuit board 10 is double-sided. In an example of the invention, the circuit board 10 is provided with LEDs 11 on one surface and electronic components 20 on the other surface. As such, the circuit board 10 and LEDs 11 are opto-electrically integrated into a LED illuminating module 1.

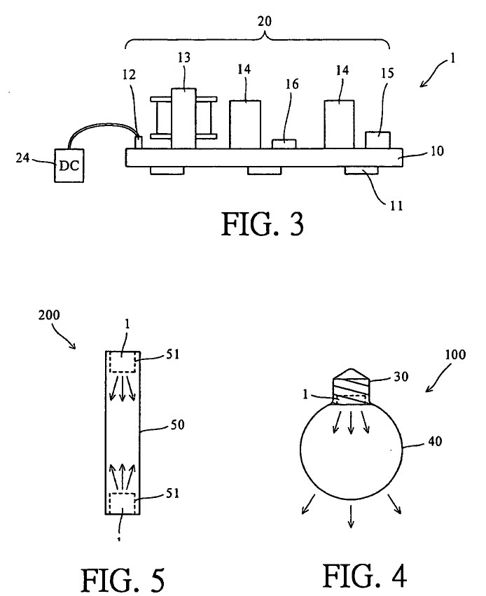

According to the LED illuminating module 1 of the present invention, its electrical terminal 12 can be externally connected with a power converter 22 that converts the external AC power into DC power to supply voltage for controller 15 and power for driving LEDs (see FIG. 2). The controller 15 can also be a light color controller. Alternatively, the electrical terminal 12 can be externally connected with a DC power supply 24, e.g. a battery to supply voltage for controller 15 and power for driving LED 11 (see FIG. 3).

The present invention provides an illuminating device 100. That is, the LED illuminating module 1 of the invention is provided inside the connector 30 of a light bulb 100, and the metal connector 30 is electrically connected with the circuit board 10 of LED illuminating module 1. The connector 30 of light bulb 100 may be connected with an electrically insulated light-transmitting shell 40. When light bulb 100 is mounted on a socket and supplied with power, these LEDs 11 of the LED illuminating module 1 will give out light, and the light will cast on external areas through shell 40 (transparent or translucent material) to provide illumination (see FIG. 4).

The present invention provides another illuminating device 200. That is, the LED illuminating module 1 of the invention may be disposed at one end or both ends of an acrylic rod 50 (referring to FIG. 5, which shows an example of being disposed at both ends). Preferably, the acrylic rod 50 has a recess 51 at one end or both ends thereof for accommodating the LED illuminating module 1 and supplying power to it. When the power is on causing the LEDs of LED illuminating module 1 to give out light, the entire acrylic rod 50 is practically a light rod. The surface of the acrylic rod 50 may be subjected to diffusion treatment or its interior may be subjected to bubble treatment to give the illumination of LED more variations through refraction or reflection and allow the module to be used in art decorative floor tiles and all kinds of illuminating devices.

By conjoining the LED and circuit board, the LED illuminating module of the present invention offers the advantages of light weight, thinness, small volume, easy application, and reduced assembly time and cost.

What is claimed is:

1. A LED illuminating module, comprising:
a circuit board; and
a plurality of LEDs disposed on said circuit board to conjoin the LEDs and circuit board together.

2. The LED illuminating module according to claim 1, wherein the circuit board comprises electronic components, including transformer, controller, capacitor, resistor or electrical terminal.

3. The LED illuminating module according to claim 2, wherein said electrical terminal is externally connected with a power converter.

4. The LED illuminating module according to claim 2, wherein said electrical terminal is externally connected with a battery.

5. A device using the LED illuminating module of claim 1, comprising a connector, and a light-transmitting shell disposed on said connector with said LED illuminating device mounted inside the connector and electrically connected to it.

6. A device using the LED illuminating module of claim 1, comprising an acrylic rod and a LED illuminating module disposed at one end of said acrylic rod, said acrylic rod having a recess at one end for accommodating said LED illuminating module.
